(19) United States
(12) Patent Application Publication
(10) Pub. No.: US 2021/0241430 A1
(43) Pub. Date: Aug. 5, 2021

(54) METHODS, DEVICES, AND COMPUTER PROGRAM PRODUCTS FOR IMPROVED 3D MESH TEXTURING

(71) Applicant: SONY CORPORATION, Tokyo (JP)

(72) Inventors: Fredrik MATTISSON, Lund (SE); Pal SZASZ, Lund (SE); Stefan KARLSSON, Göteborg (SE)

(73) Assignee: Sony Corporation, Tokyo (JP)

(21) Appl. No.: 17/049,223

(22) PCT Filed: Sep. 13, 2018
(86) PCT No.: PCT/US2018/050799

§ 371 Date: Oct. 20, 2020

(51) Int. Cl. G06T 5/00; G06T 5/50; G06T 15/04; G06T 17/20

(52) U.S. Cl. CPC G06T 5/002; G06T 5/50; G06T 2207/20221; G06T 17/205; G06T 2207/20224; G06T 15/04

(57) ABSTRACT

Methods, systems, and computer program products for improving the generation of a 3D mesh texture include extracting a plurality of high frequency image components and a plurality of low frequency image components from a plurality of two-dimensional (2D) images of a three-dimensional (3D) object captured at respective points of perspective of the 3D object, generating a low frequency texture atlas from the plurality of low frequency image components, generating a high frequency texture atlas from the plurality of high frequency image components by performing a texturing operation comprising seam leveling on a subset of the plurality of high frequency image components, and generating the texture atlas by merging the low frequency texture atlas with the high frequency texture atlas.

### FIELD

Various embodiments described herein relate to methods and devices for image processing and, more particularly, to three-dimensional (3D) modeling.

### BACKGROUND

Three-dimensional (3D) modeling may be used to create a representation of an object for use in a variety of applications, such as augmented reality, 3D printing, 3D model development, and so on. A 3D model may be defined by a collection of points in 3D space connected by various geometric entities such as triangles, lines, curved surfaces, or the like. One potential way to generate a 3D model of an object is via 3D scanning of the object. Although there are various methods to perform 3D scanning, one area of potential growth and development includes capturing a set of images by an image capture device. A collection of points in 3D space may be determined from corresponding feature points in the set of images. A mesh representation (e.g., a collection of vertices, edges, and faces representing a “net” of interconnected primitive shapes, such as triangles) that defines the shape of the object in three dimensions may be generated from the collection of points. Refinements to the mesh representation may be performed to further define details.

Creating a 3D mesh of an object only provides one component of the overall 3D model. In order for the virtual representation of the object to look realistic, color information is desirable. Known systems simply utilize a per-vertex color: for each vertex of the mesh a color triplet (RGB) may be specified. The color for each pixel in the rendered mesh may be interpolated from these colors. The color resolution for per-vertex methods may be very low, and the resultant model may have a low degree of detail and may not be realistic.

Texturing is one technique that may achieve better color quality than the per-vertex color methods. In texturing, one or several images are created in addition to the 3D mesh, and these images may be mapped onto the surface of the mesh. For each primitive shape (e.g., triangle) in the mesh there is a corresponding triangle in the texture image.

A texture image may be created from the 3D mesh and the set of images captured by an image capture device. However it has been recognized by the inventors that many challenges are present in texturing and in the creation of the texture image.

### SUMMARY

Various embodiments described herein provide methods, systems, and computer program products for generating an improved texture for a 3D model.

Various embodiments of present inventive concepts include a method of generating a texture atlas including extracting a plurality of high frequency image components and a plurality of low frequency image components from a plurality of two-dimensional (2D) images of a 3D object captured at respective points of perspective of the 3D object, generating a low frequency texture atlas from the plurality of low frequency image components, generating a high frequency texture atlas from the plurality of high frequency image components by performing a texturing operation comprising seam leveling on a subset of the plurality of high frequency image components, and generating the texture atlas by merging the low frequency texture atlas with the high frequency texture atlas.

Various embodiments of present inventive concepts include a system including a processor and a memory coupled to the processor and storing computer readable program code that when executed by the processor causes the processor to perform operations including extracting a plurality of high frequency image components and a plurality of low frequency image components from a plurality of 2D images of a 3D object captured at respective points of perspective of the 3D object, generating a low frequency texture atlas from the plurality of low frequency image components, generating a high frequency texture atlas from the plurality of high frequency image components by performing a texturing operation comprising seam leveling on a subset of the plurality of high frequency image components, and generating the texture atlas by merging the low frequency texture atlas with the high frequency texture atlas.

Various embodiments of present inventive concepts include a computer program product for operating an imaging system, the computer program product comprising a non-transitory computer readable storage medium having computer readable program code embodied in the medium that when executed by a processor causes the processor to perform a method including extracting a plurality of high frequency image components and a plurality of low frequency image components from a plurality of two-dimensional (2D) images of a 3D object captured at respective points of perspective of the 3D object, generating a low frequency texture atlas from the plurality of low frequency image components, generating a high frequency texture atlas from the plurality of high frequency image components by performing a texturing operation comprising seam leveling on a subset of the plurality of high frequency image components, and generating the texture atlas by merging the low frequency texture atlas with the high frequency texture atlas.

In some embodiments, extracting the plurality of low frequency image components from the plurality of 2D images of the 3D object comprises performing a blurring operation on respective ones of the plurality of 2D images.

In some embodiments, extracting the plurality of high frequency image components from the plurality of 2D images comprises subtracting respective ones of the low frequency image components from respective ones of the plurality of 2D images.

Some embodiments may further include extracting a plurality of high frequency intermediate image components from the plurality of 2D images, extracting a plurality of middle frequency intermediate image components from the plurality of 2D images, and extracting a plurality of low frequency intermediate image components from the plurality of 2D images, where extracting the plurality of high frequency image components comprises merging the plurality of high frequency intermediate image components and the plurality of middle frequency intermediate image components, and generating the plurality of low frequency image components comprises merging the plurality of low frequency intermediate image components and the plurality of middle frequency intermediate image components.

Some embodiments may further include generating a plurality of first blurred images by performing a blurring operation on respective ones of the plurality of 2D images, and generating a plurality of second blurred images by performing the blurring operation on respective ones of the plurality of first blurred images. In some embodiments, extracting the plurality of low frequency intermediate image components from the plurality of 2D images comprises selecting the plurality of second blurred images, extracting the plurality of middle frequency intermediate image components from the plurality of 2D images comprises subtracting respective ones of the plurality of second blurred images from respective ones of the plurality of first blurred images, and extracting the plurality of high frequency intermediate image components from the plurality of 2D images comprises subtracting respective ones of the plurality of first blurred images from respective ones of the plurality of 2D images.

In some embodiments, a first number of the subset of the plurality of high frequency image components is less than a second number of the plurality of low frequency image components.

Some embodiments may further include selecting a first high frequency image component of the plurality of high frequency image components as part of the subset of the plurality of high frequency image components based on a quality of the first high frequency image component, an orientation of the first high frequency image component with respect to the 3D object, and/or a distance to the 3D object from which the first high frequency image component was captured.

In some embodiments, the texturing operation comprising seam leveling comprises a Markov random field optimization operation.

In some embodiments, generating the low frequency texture atlas based on the plurality of low frequency image components comprises summing, for each low frequency image component of the plurality of low frequency image components, a color value of the low frequency image component multiplied by a weight value.

Advantageously, these embodiments may provide an efficient processing method which performs a frequency separation utilizing high and low frequency image components to generate high and low frequency texture atlases that results in an improved texture atlas with fewer artifacts. In some embodiments, only a subset of the high frequency image components may be provided to generate the high frequency texture atlas, which may require fewer processing resources, while still generating a high quality high frequency texture atlas. In some embodiments, a low frequency texture atlas may be generated from the full set of low frequency image components using operations that are efficient with respect to processor and memory resources, thus generating the low frequency texture atlas efficiently while including the full set of information from the low frequency image components. The use of the full set of information from the low frequency image components may provide a higher dynamic range in the low frequency texture atlas as compared to operations which use a single keyframe image to generate portions of the texture atlas. Thus, a high quality final texture atlas may be generated, while not requiring the full time to iterate over all of the keyframe images for the texturing operation.

It is noted that aspects of the inventive concepts described with respect to one embodiment, may be incorporated in a different embodiment although not specifically described relative thereto. That is, all embodiments and/or features of any embodiment can be combined in any way and/or combination. Other operations according to any of the embodiments described herein may also be performed. These and other aspects of the inventive concepts are described in detail in the specification set forth below.

### BRIEF DESCRIPTION OF THE DRAWINGS

The above and other objects and features will become apparent from the following description with reference to the following figures, wherein like reference numerals refer to like parts throughout the various figures unless otherwise specified.

FIG. 1 illustrates the use of a camera as part of a 3D construction of an object, according to various embodiments described herein.

FIGS. 2A, 2B, and 2C illustrate examples of keyframe images used to generate a 3D mesh.

FIG. 3A illustrates an example of formulating a 3D mesh from a point cloud.

FIG. 3B illustrates an example of a completed mesh representation.

FIG. 3C is a diagram illustrating the relationship between a texture atlas and a mesh representation.

FIG. 4 is a block diagram illustrating the creation of a texture atlas using frequency separation and a texturing operation utilizing seam leveling, according to various embodiments described herein.

FIG. 5 is a flowchart of operations for creating a texture atlas using frequency separation and a texturing operation utilizing seam leveling, according to various embodiments described herein.

FIGS. 6A-6D are block diagrams and flowcharts illustrating various aspects of a sub-operation of FIG. 5 for extracting high and low frequency image components from keyframe images, according to various embodiments described herein.

FIG. 7 is a block diagram of an electronic device capable of implementing the inventive concepts, according to various embodiments described herein.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

Applications such as 3D imaging, mapping, and navigation may use techniques such as Simultaneous Localization and Mapping (SLAM), which provides a process for constructing and/or updating a map of an unknown environment while simultaneously keeping track of an object's location within it. 2D images of real objects may be captured with the objective of creating a representation of a 3D object that is used in real-world applications such as augmented reality, 3D printing, and/or 3D visualization with different perspectives of the real objects. As described above, the generated 3D representation of the objects may be characterized by feature points that are specific locations on the physical object in the 2D images that are of importance for the 3D representation such as corners, edges, center points, and other specific areas on the physical object. There are several algorithms used for solving this computational problem associated with 3D imaging, using various approximations. Popular approximate solution methods include the particle filter and Extended Kalman Filter (EKF). The particle filter, also known as a Sequential Monte Carlo (SMC), linearizes probabilistic estimates of data points. The Extended Kalman Filter is used in non-linear state estimation in applications including navigation systems such as Global Positioning Systems (GPS), self-driving cars, unmanned aerial vehicles, autonomous underwater vehicles, planetary rovers, newly emerging domestic robots, medical devices inside the human body, and/or imaging systems. Imaging systems may generate 3D representations of an object using SLAM techniques by performing a transformation of the object in a 2D image to produce a representation of a physical object. The 3D representation may ultimately be a mesh that defines a surface of the representation of the object.

Once generated, the 3D representation and/or mesh may be further updated to include a surface texture, which can provide colors and/or other details to make the 3D representation more realistic. The 2D images used to create the 3D representation may be used to provide a source for the texture to be applied to the 3D representations. Various embodiments described herein may arise from recognition that techniques such as those described herein may provide for a more efficient generation of a texture for a 3D representation that is of higher quality than conventional techniques.

The 2D images used in the methods, systems, and computer program products described herein may be captured with image sensors. Image sensors may be collocated with or integrated with a camera. The terms “image sensor,” and “camera” will be used herein interchangeably. The camera may be implemented with integrated hardware and/or software as part of an electronic device, or as a separate device. Types of cameras may include mobile phone cameras, security cameras, wide-angle cameras, narrow-angle cameras, stereoscopic cameras and/or monoscopic cameras.

Generating a 3D mesh of a physical object may involve the use of a physical camera to capture multiple images of the physical object. For instance, the camera may be rotated around the physical object being scanned to capture different/portions perspectives of the physical object. Based on the generated images, a mesh representation of the physical object may be generated. The mesh representation may be used in many different environments. For example, the model of the physical object represented by the mesh representation may be used for augmented reality environments, 3D printing, entertainment and the like.

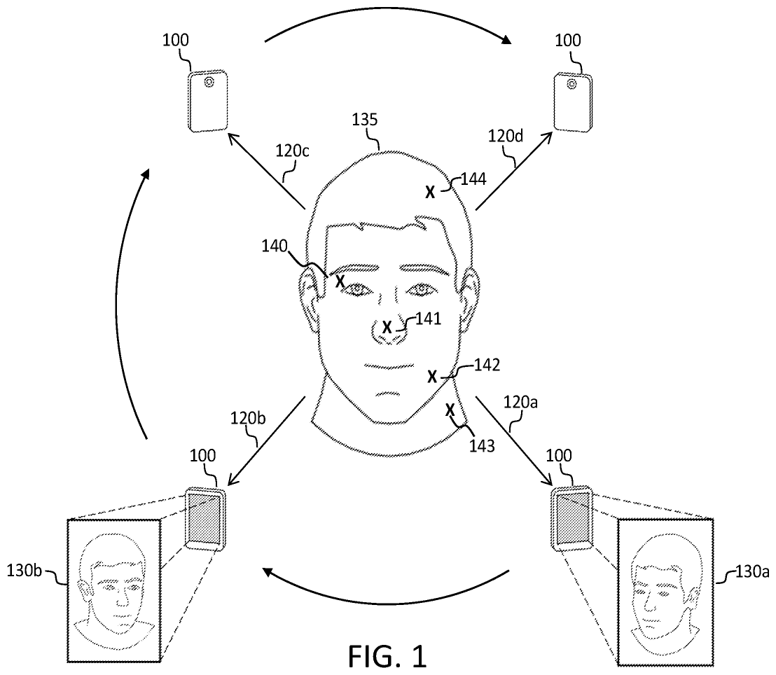

As part of context for the present application, FIG. 1 illustrates the use of a camera 100 as part of a 3D construction of an object 135, according to various embodiments described herein. For example, as illustrated in FIG. 1, a camera 100 may be used to take a series of images (e.g., 130a, 130b) of the object 135, such as a person's face or other object, at location 120a. The camera 100 may be physically moved around the object 135 to various locations such as location 120b, location 120c, and/or location 120d. Though only four camera locations are illustrated in FIG. 1, it will be understood that more or fewer camera locations may be used to capture images of the object 135. In some embodiments, the object 135 may be moved in relation to the camera 100. One or more images of the object 135 may be captured at each location. For example, image 130a may be captured when the camera 100 is at location 120a and image 130b may be captured when the camera 100 is at location 120b. Each of the captured images may be 2D images. There may be a continuous flow of images from the camera 100 as the camera 100 moves around the object 135 that is being scanned to capture images at various angles. Once the images, such as images 130a and 130b are captured, the images may be processed by a processor in camera 100 and/or a processor external to the camera 100 to generate a 3D image. In some embodiments, a baseline initialization of the 3D image may occur once the first two images are captured. The quality of the baseline initialization may be evaluated to see if a satisfactory baseline initialization has occurred. Otherwise, further processing of additional images may take place.

In some embodiments, the baseline initialization may indicate the object 135 to be scanned, as well as overall rough dimensions of the object 135. An initial mesh representation may be formed to enclose the dimensions of the object 135, and further images may be repeatedly processed to refine the mesh representation of the object 135.

The images may be processed by identifying points on the object 135 that were captured the first image 130a, the second image 130b, and/or subsequent images. The points may be various edges, corners, or other points on the object 135. The points are recognizable locations on the physical object 135 that may be tracked in various images of the physical object 135. Still referring to FIG. 1, points on the object 135 may include points 140 through 144. When the camera 100 moves to a different location 120b, another image 130b may be captured. This same process of capturing images and identifying points may occur on the order of tens, hundreds, or thousands (or more) of times in the context of creating a 3D representation. The same points 140 through 144 may be identified in the second image 130b. The spatial coordinates, for example, the X, Y, and/or Z coordinates, of the points 140 through 144 may be estimated using various statistical and/or analysis techniques.

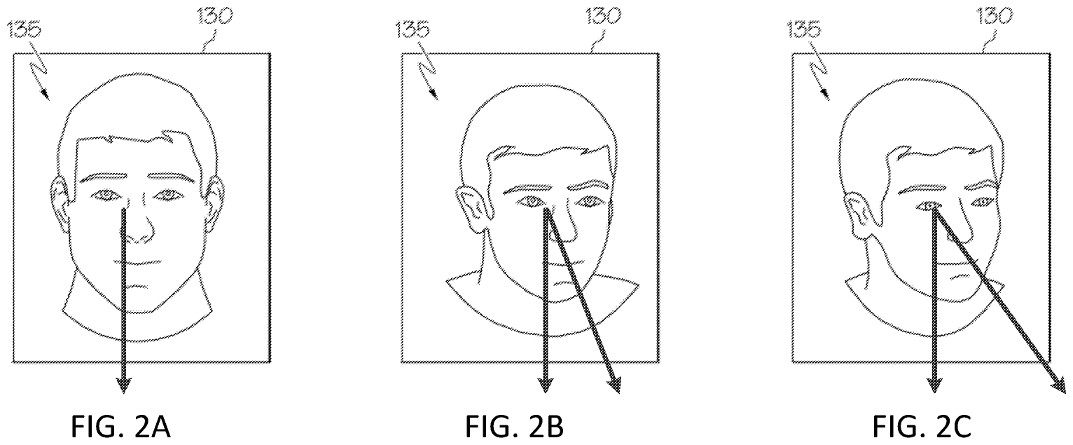

FIGS. 2A, 2B, and 2C illustrate various images, referred to as keyframe images 130, of an object 135. From among the series of images taken as discussed with respect to FIG. 1, specific images known as keyframe images 130 may be selected. A keyframe image 130 may be an anchor frame, selected from among the many pictures taken of the object 135 based on certain criteria, like a stable pose, and/or even light, color, and/or physical distribution around the object. The keyframe images 130 may be a subset of all of the images (e.g., images 130a, 130b of FIG. 1) that are taken of the object 135. The keyframe images 130 may be stored with additional metadata, such as, for example, the pose information of the camera that captured the image. The pose information may indicate an exact location in space where the keyframe image 130 was taken.

Referring now to FIG. 2A, in a first keyframe image 130, the object 135 is oriented straight at the camera. Referring now to FIG. 2B, in a second keyframe image 130, the camera is offset from a perpendicular (e.g., straight-on and/or normal) view of the object 135 by about 30 degrees. Referring now to FIG. 2C, in a third keyframe image 130, the camera is offset from a perpendicular (e.g., straight-on and/or normal) view of the object 135 by about 45 degrees. Thus, keyframe images 130 of FIGS. 2A, 2B, and 2C illustrate approximately 45 degrees of the object 135.

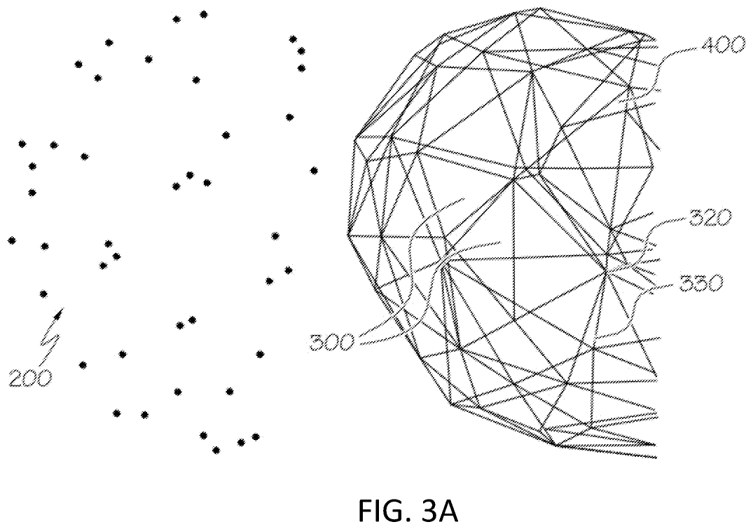

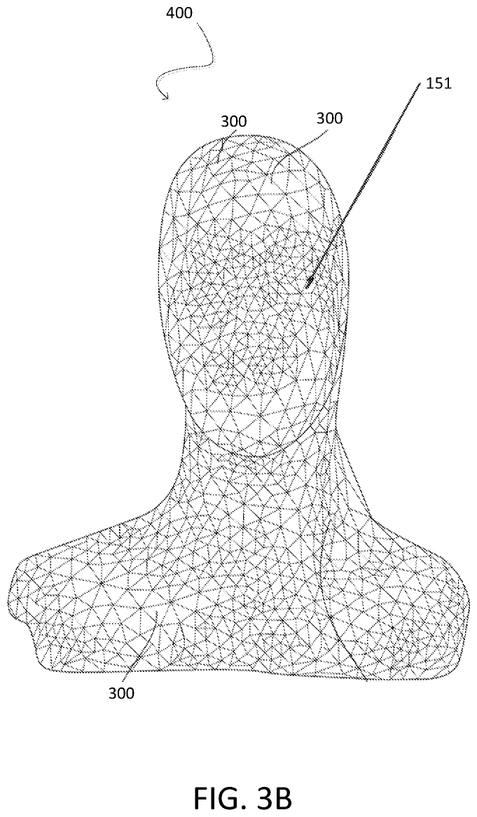

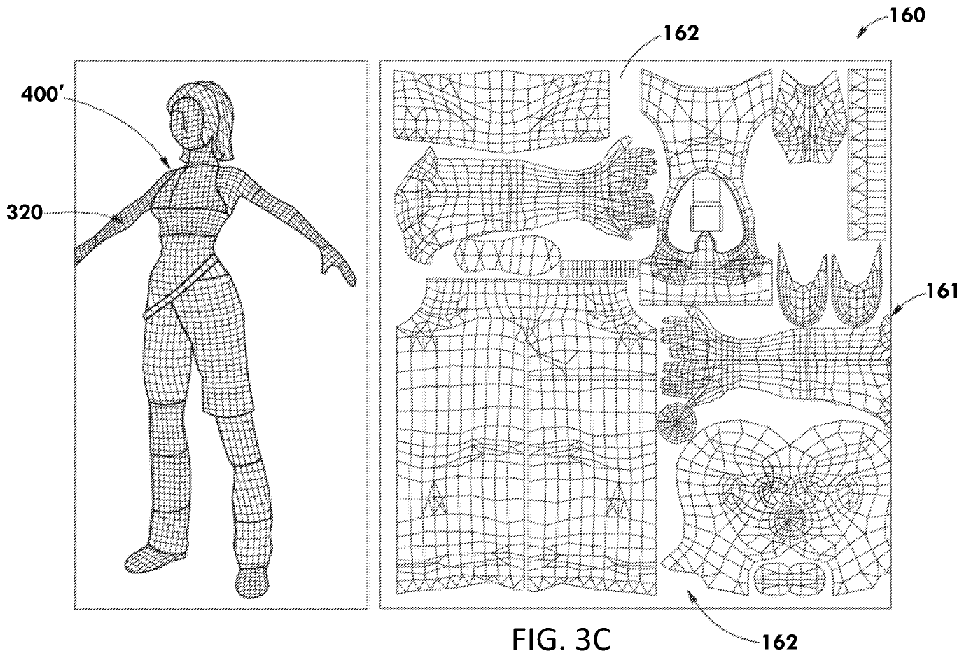

FIG. 3A illustrates the generation of a point cloud 200 and mesh representation 400 based on a 2D image, according to various embodiments described herein. As illustrated in FIG. 3A, analysis of the orientation and position information of a set of images (e.g., images 130a and 130b of FIG. 1) may result in the identification of points (e.g., points 140 through 144 of FIG. 1), which may collectively be referred to as point cloud 200, which is a plurality of points 200 identified from respective images of the object 135. From these identified plurality of points 200, characteristics of the mesh representation 400 of the object 135 may be updated. As described herein, the mesh representation 400 may be composed of a plurality of polygons 300 including edges 330 and vertices 320.

Respective vertices 320 of the mesh representation 400 may be associated with the surface of the object 135 being scanned and tracked. The point cloud 200 may represent contours and/or other features of the surface of the object 135. Operations for generating a mesh representation 400 of the object 135 may attempt to map the point cloud 200 extracted from a 2D image of the object 135 onto the polygons 300 of the mesh representation 400. It will be recognized that the mesh representation 400 is incrementally improved based on subsequent images, as the subsequent images provide additional points to the point cloud 200 which may be mapped to the plurality of polygons 300 of the mesh representation 400.

Refining the mesh representation 400 given a point cloud 200 may involve mathematically projecting the 3D location of the plurality of points 200 inferred from an image into and/or onto the mesh representation 400. For each point of the plurality of points 200, an analysis may be performed to determine whether the point lays on the mesh representation 400, or whether the point is off (e.g., above/below/beside in a 3D space) the mesh representation 400. If the point is on the mesh representation 400, the point may be associated with a polygon of the polygons 300 of the mesh representation 400 that contains the point. If the point is off the mesh representation 400, it may indicate the mesh representation 400 needs to be adjusted. For example, the point may indicate that the arrangement of the polygons 300 of the current mesh representation 400 is inaccurate and needs to be adjusted.

In some embodiments, to adjust the mesh representation 400, a vertex 320 of one of the polygons 300 of the mesh representation 400 may be moved to a location in 3D space corresponding to the point of the point cloud 200 being analyzed. In some embodiments, to adjust the mesh representation 400, the polygons 300 of the mesh representation 400 may be reconfigured and/or new polygons 300 added so as to include a location in 3D space corresponding to the point of the point cloud 200 being analyzed in the surface of the mesh representation 400. In some embodiments, the adjustment of the mesh representation 400 may be weighted so that the mesh representation 400 moves toward, but not entirely to, the location in 3D space corresponding to the point of the point cloud 200 being analyzed. In this way, the mesh representation 400 may gradually move towards the points of a point cloud 200 as multiple images are scanned and multiple point clouds 200 are analyzed.

FIG. 3B illustrates an example of a completed mesh representation 400 of an object 135 that may be generated, for example, from a set of keyframe images such as keyframe images 130 of FIGS. 2A-2C. Referring to FIG. 1B, a mesh representation 400 of the object 135 may include an exterior surface 151 that includes a plurality of polygons 300. The plurality of polygons 300 may provide a representation of an exterior surface of the object 135. For example, the plurality of polygons 300 may model features (such as features at the points 140-144 of FIG. 1) on the exterior surface of the object 135. In some embodiments, the plurality of polygons 300 may include a plurality of triangles, and are referred to as such herein. Each of the plurality of polygons 300 may have one or more vertices, which may be represented by a three-dimensional coordinate (e.g., a coordinate having three data values, such as an x-value, a y-value, and a z-value). This may be referred to herein as a “3D-coordinate.”

A mesh representation, such as the mesh representation 400 of FIG. 3B, is one component of a 3D model of the 3D object. In order for the virtual representation of the object to look realistic, it is desirable to add color, detail, or other texture information. This information may be stored in a texture (also referred to herein as a “texture atlas”). FIG. 3C is a diagram illustrating the relationship between a texture 160 and a mesh representation 400′. Mesh representation 400′ of FIG. 3C and the mesh representation 400 of FIG. 3B are similar, though they differ in that one is a mesh representation of a head only and the other is a mesh representation of an entire body. In addition to a three-dimensional coordinate, each vertex 320 may have a two-dimensional texture coordinate (e.g., a coordinate having two data values, such as a u-value and a v-value) indicating which part of the texture 160 corresponds to the vertex 320. The texture coordinate may be referred to herein as a “UV coordinate.” A rendering engine may then apply, or sample, the texture atlas 160 to the vertices 320, in effect “painting” each vertex, or each triangle of the mesh representation 400′, with the corresponding part of the texture 160. As seen in FIG. 1C, texture 160 may have one or more islands 161, where color or other texture information associated with vertices may be located, separated by gaps 162, where color, detail, surface texture or other texture information not associated with vertices may be located. In some embodiments, this may be some static color (e.g., black).

One aspect in generating a 3D model includes recognizing that the model may be presented or displayed on a two-dimensional display device (though this is not the only possible output of generating a 3D model). Computer graphics systems include algorithms to render a 3D scene or object to a 2D screen. When rendered on a display device, the mesh may be combined in a way with the texture, by taking the 3D coordinate of the vertices and projecting them into a screen space using a camera position and parameters. These values may be provided, for example, to a vertex shader. Each pixel from the texture may be sampled using the UV coordinates. This may be performed, for example, in a fragment shader.

As discussed above with respect to FIG. 1, a camera 100 may be used to capture a plurality of images (e.g., images 103a, 130b) of a physical object 135, such as a head of a person, at different locations (e.g., locations 120a, 120b, 120c, 120d). The camera 100 may be physically moved around the physical object 135 to various locations, such as from the location 120a to a different location 120b. An image of the physical object 135 may be captured at each location. For example, image 130a is captured when the camera 100 is at the location 120a, and image 130b is captured when the camera 100 moves to the different location 120b.

It has been recognized by the inventors that creation of a texture having a high degree of detail is desirable. The captured images may be used not only to generate a mesh representation of the object, but also to derive color and detail information to use in generating a texture for the 3D model of the object. Additionally, it is desirable that the creation of the texture be completed in a relatively short timeframe using as little memory resources as possible, both from a computational savings (e.g., efficiency and/or hardware cost) perspective and from a user satisfaction perspective. It is known that there is at least one texture creation algorithm, provided in an article by Waechter et al. entitled “Let There Be Color! Large-Scale Texturing of 3D Reconstructions,” European Conference on Computer Vision, Springer, Cham, 2014 (hereinafter referred to as “Waechter”). The inventors have recognized several deficiencies with the Waechter methods. In the Waechter methods, for example, a global optimization is performed first, in which an input image (e.g., a keyframe image) for each triangle in the mesh is selected, with the result that each triangle in the mesh will be painted with data from one single camera image. The inventors have recognized that this has the potential to produce sub-optimal results in some situations of conventional usage, for example where the mesh is of a lower resolution and where the resulting texture of the triangles is of a higher resolution. The Waechter methods also contain a complicated color adjustment step in order to handle global illumination differences, which can result in undesirable artifacts that may affect large regions of the resulting texture atlas when applied to a set of original keyframe images.

Other conventional techniques which map a keyframe image to each triangle of a mesh representation may have similar deficiencies as that described above with Waechter. In such algorithms each keyframe image may be analyzed together with the mesh representation, and a decision may be made to assign a single keyframe per mesh triangle as its source of texture. After a unique keyframe is assigned to each triangle of the mesh representation, the keyframe images may be respectively projected onto each respective triangle. This technique may give rise to extremely strong seams when adjacent triangles having different keyframe images are next to each other. Some techniques deal with this phenomenon by “seam leveling.” Some techniques include both local seam leveling and global seam leveling. Local seam leveling may affect only a small region around the seams, while global seam leveling may adjust the level of brightness in the entire keyframe image to match neighboring frames with minimized seams. Texturing operations which include techniques such as these are the open source mvs-texturing algorithm that is described, in part, in the Waechter paper discussed herein. Other texturing operations which utilize Markov random field optimization operations may have similar issues, such as that described in Lempitsky et al., “Seamless Mosaicing of Image-Based Texture Maps,” 2007 IEEE Conference on Computer Vision and Pattern Recognition, Minneapolis, Minn., 2007, pp. 1-6, and Dou et al., “High Quality Texture Mapping for Multi-view Reconstruction,” 2017 2nd International Conference on Multimedia and Image Processing (ICMIP), Wuhan, 2017, pp. 136-140. An example of a texturing algorithm that is not strictly formulated as a Markov random field optimization is described in Wang et al., “Improved 3D-model texture mapping with region-of-interest weighting and iterative boundary-texture updating,” 2016 IEEE International Conference on Multimedia & Expo Workshops (ICMEW), Seattle, Wash., 2016, pp. 1-6. While seam leveling can improve some textures, the seam leveling itself may make new artifacts appear, albeit milder than the original seams. The inventors have recognized that the techniques described herein may minimize the new artifacts that texturing operations such as mvs-texturing cause, while maintaining the beneficial effects of the seam leveling. While reference is made to mvs-texturing operations herein, the techniques described herein may be applied to other texturing operations, such as those incorporating seam leveling.

Another undesirable effect of texturing techniques is known as “ghosting.” When many images are combined to produce a consistent texture, irregularities may occur due to non-static objects and/or inaccuracies in camera pose estimation. These effects may often take the appearance of odd, transparent, texture patterns (hence the name “ghosting”). The inventors have recognized that the techniques described herein may provide additional benefits in the reduction of ghosting in a generated texture.

Finally, the inventors have recognized that minimizing resources needed to generate a texture may be beneficial. Even in environments in which generating the texture may be sent (e.g., via a network) to a separate server, the time taken to generate a texture for a given mesh representation may impact a user's satisfaction with a process. Thus, techniques such as those described herein represent a technical improvement in the generation of a mesh representation of an object in that they can provide a higher quality texture for the mesh representation while using fewer resources.

To achieve these and other objectives, provided herein are operations for creating a texture atlas using frequency separation in combination with a texturing operation incorporating seam leveling operations. As will be discussed further below, frequency separation includes the splitting of one or more images each into higher frequency components (which may include finer details such as facial pores, lines, birthmarks, spots, or other textural details) and lower frequency components (such as color or tone). As will be discussed further below, the combination of seam leveling with frequency separation may reduce and/or minimize variations in a given texture between triangles of a mesh.

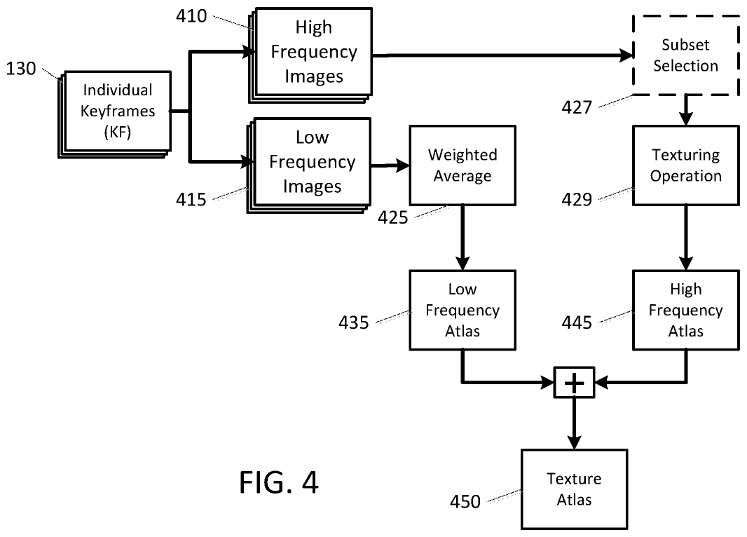

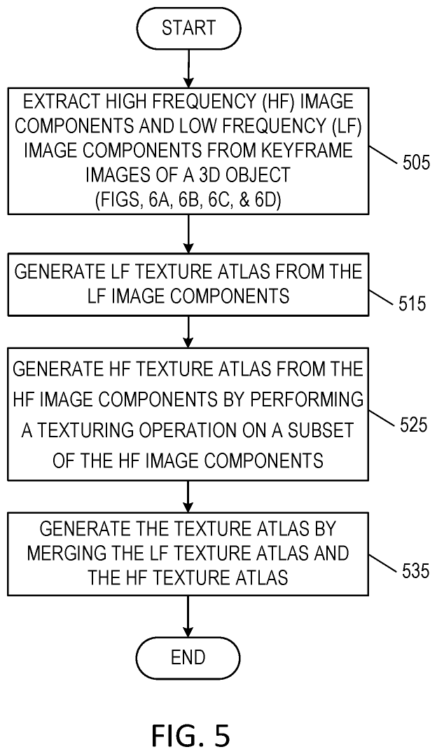

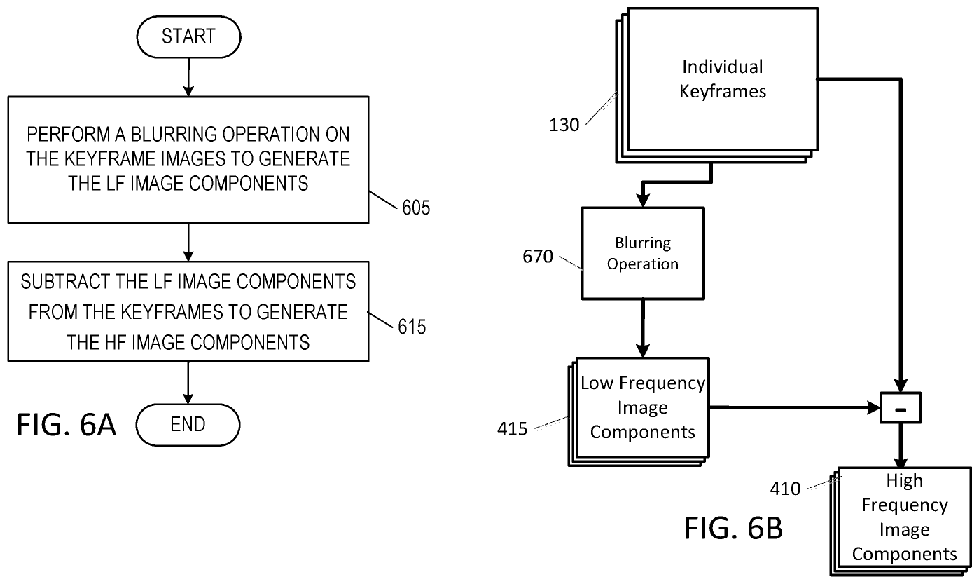

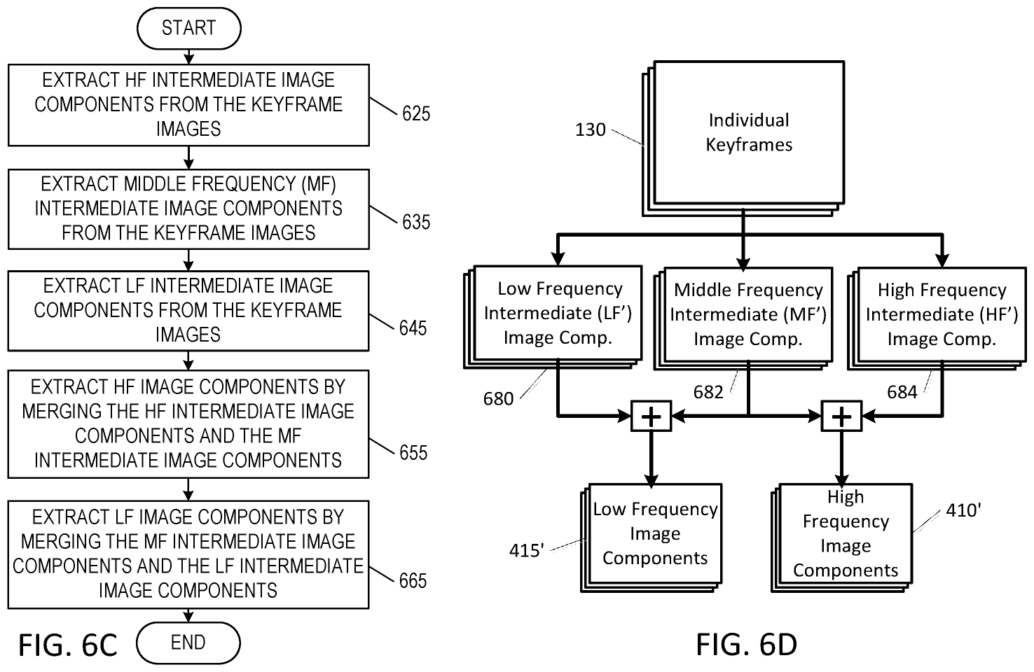

As an example of the operations provided herein, FIG. 4 is a block diagram, and FIG. 5 is a flowchart, of operations for creating a texture atlas using frequency separation and a texturing operation utilizing seam leveling. FIGS. 6A-6D are block diagrams and flowcharts illustrating various aspects of a sub-operation of FIG. 5 for extracting high and low frequency image components from keyframe images, according to various embodiments described herein. One or more electronic devices, including electronic devices interconnected via a network, may be configured to perform any of the operations in the flowcharts of FIGS. 4-6D. As shown in FIGS. 4-6D, some operations (e.g., Blocks 505, 605, 615, 625, 635, 645, 655, and 665) may be repeated for each image of the keyframe image data 130. Also, although the operations of FIG. 4 result in a single final texture atlas, in some embodiments multiple texture atlases may be generated.

Referring to FIGS. 4 and 5, operations for creating a texture include extracting high frequency (HF) image components 410 and low frequency (LF) image components 415 from the keyframe images 130 of a 3D object 135 (Block 505). Example, techniques for extracting HF and LF image components are described in commonly-assigned International Patent Application No. PCT/US17/49580, filed Aug. 31, 2017, entitled “METHODS, DEVICES, AND COMPUTER PROGRAM PRODUCTS FOR 3D MESH TEXTURING,” the entire contents of which are included by reference herein. Additional operations for generating the low frequency image components 415 and the high frequency image components 410 are described herein with respect to FIGS. 6A-6D. In some embodiments, a low frequency image component 415 and a high frequency image component 410 may be generated for each of the keyframe images 130.

Once the low frequency image components 415 have been generated, they may be used to generate a low frequency texture atlas (Block 515). As discussed above, the low frequency image component 415 may include the overall color of the object 135. Although this data may be sensitive to illumination differences (e.g., because of lighting differences in the environment where the keyframe images 130 were captured), the low frequency image components 415 may not include, or may include fewer, details of the object 135.

In some embodiments, a weighted average 425 is used to combine low frequency image components 415 of different keyframe images 130 (see FIG. 4). For example, a first low frequency image component 415 from a first keyframe image 130 and a second low frequency image component 415 from a second keyframe image 130 may be added together on a per-pixel basis. Each pixel may receive a weight. Color data stored in color channels (e.g., red-green-blue (RGB) channels) of the pixel may be pre-multiplied with this weight. In some aspects, the weight may be calculated based on the viewing direction and the triangle normal (or a normal of another polygon representing the object 135). For example, higher weights may be given if the corresponding triangle is facing towards the camera. In some embodiments the weight may be based on confidence measures from the pose and/or 3D calculations associated with the keyframe images 130, with a lower weight given to those elements with a lower confidence. In some embodiments, the weight may be based on the lens focus of the keyframe image 130, with a keyframe image 130 that is more in focus receiving a higher weight.

In some embodiments, the process of weighted averaging 425 may begin with an initial low frequency texture atlas 435. The process may continue with processing pixels of interest of respective ones of the keyframe images 130. Each keyframe image 130 may have pixels of interest that correspond to views of the triangles of the mesh representation. For example, if a given pixel of the keyframe image 130 only illustrates a background of the 3D object 135 it may not be a pixel of interest. For each pixel of interest, the RGB value (e.g., the data value for each channel of the RGB data) may be added to the low frequency texture atlas 435 at the location in the low frequency texture atlas 435 that corresponds to the location on the 3D object 135 represented by the pixel. After processing all of the pixels of interest of all of the keyframe images 130, the low frequency texture atlas 435 may contain weighted sums of all of the pixels of interest at various locations within the low frequency texture atlas 435. These weighted sums may be normalized by dividing by the sum of all the weights.

Although the RGB color space is discussed above, in some aspects, a different color space may be used. For example, hue-saturation-lightness (HSL) color spaces or luma, blue-difference chroma, and red-difference chroma (YCrCb) color spaces may be used. This may permit the usage of standard deviation to adjust the final YCrCb values. For example, using the YCrCb color space may permit the retention of a more saturated value, by increasing the CrCb channels based on standard deviation as well as retention of darker values by decreasing the Y channel. This may assist in the removal of specular highlights.

Though the above example describes a particular procedure (weighted average) 425 for generating the low frequency texture atlas 435, it will be understood that other techniques may be used to generate the low frequency texture atlas 435 from the low frequency image components 415, without deviating from the embodiments described herein.

The high frequency image components 410 that are extracted may also be used to generate a high frequency texture atlas 445 (Block 525). The high frequency image components 410 may be processed through a texturing operation 429 that incorporates seam leveling to generate the high frequency texture atlas 445. In some embodiments, not all of the high frequency image components 410 may be provided to the texturing operation 429. Instead, a subset, smaller than the total number, of the high frequency image components may be selected for processing to form the high frequency texture atlas 445. In some embodiments, the subset of the high frequency image components may be selected 427 based on a quality of the high frequency image component 410, an orientation of the high frequency image component 410 with respect to the 3D object 135, and/or a distance to the 3D object 135 from which the high frequency image component 410 was captured. Selecting the subset 427 of high frequency image components 410 may be an optional step in some embodiments.

As discussed above, the high frequency image components 410 may include less of color components of the object 135, but more of the detail elements. For example, in some embodiments, the high frequency image components 410 may include zero average color and contain only fine detail elements of the object 135. Because the high frequency image components 410 contain less of the average color elements of the keyframe images 130, the high frequency image components 410 may be less subject to the types of strong seams that may be generated by the type of texturing operations 429 that generate a texture atlas by associating every triangle of a mesh representation with a full image. As discussed above, such texturing operations 429 may typically assign keyframe images to triangles of the mesh representation, and variances between adjacent ones of the keyframe images 130 within the mesh may result in additional artifacts in the texture atlas when seam leveling is performed to adjust the seams. By using the high frequency image components 410 as input into the texturing operations 429 (rather than the original keyframe images 130) to generate a high frequency texture atlas 445, the resulting high frequency texture atlas 445 may have less pronounced seams, and the seam leveling operations of the texturing operations 429 inject fewer artifacts into the high frequency texture atlas 445. Algorithms that may be used for the texturing operations 429 include the mvs-texturing algorithm as described in Waechter, texturing operations utilizing Markov random field optimization operations, texturing operations that solve the texturing problem as a per mesh-region labeling problem, where any region may only be textured from a single view, and/or texturing operations that are dependent on global seam-leveling. An example of an algorithm which uses a single keyframe texture to represent a region of the texture atlas is described in Chen et al. “3D Texture Mapping in Multi-view Reconstruction,” Advances in Visual Computing, ISVC 2012, Lecture Notes in Computer Science, vol 7431, Springer, Berlin, Heidelberg. Another example of an algorithm which uses a single keyframe texture to represent a region of the texture atlas is described in Allene et al. “Seamless image-based texture atlases using multi-band blending,” 2008 19th International Conference on Pattern Recognition, Tampa, Fla., 2008, pp. 1-4. Other algorithms which may be used as for the texturing operation 429 include those of Lempitsky et al., Dou et al., and Wang et al., described herein.

As previously discussed, each of keyframe images 130 may be processed to generate the low frequency texture atlas 435 and the high frequency texture atlas 445. After each keyframe image 130 has been processed, a final texture atlas 450 may be created (Block 535). The final texture atlas 450 may be generated by merging the low frequency texture atlas 435 with the high frequency texture atlas 445. Merging the low frequency texture atlas 435 with the high frequency texture atlas 445 may include a pixel-wise combination of the two texture atlases. For example, for each corresponding pixel of the low frequency texture atlas 435 and the high frequency texture atlas 445, the data channels for the pixel may be summed. For example, if RGB data is used for the underlying pixel information, combining two corresponding pixels from the low frequency texture atlas 435 and the high frequency texture atlas 445 may include summing the data from the respective red channels, blue channels, and green channels of the two pixels to create a new RGB value for the corresponding pixel in the merged texture atlas 450. The result of the merging operation is a texture atlas 450 (such as texture atlas 160 of FIG. 3C) for the 3D mesh representation (such as the mesh representation 400′ of FIG. 3C) of the 3D object.

As discussed herein, operations to generate the improved texture atlas 450 include extracting high frequency image components 410 and low frequency image components 415 from the keyframe images 130 of a 3D object 135 (Block 505). FIGS. 6A-6D illustrate example embodiments of this operation, according to some embodiments described herein.

For example, FIG. 6A is a block diagram, and FIG. 6B is a flowchart, of operations to extract high frequency image components 410 and low frequency image components 415 from the keyframe images 130, according to embodiments of the inventive concepts. Referring to FIGS. 6A and 6B, generating the low frequency image components 415 may include performing a blurring operation 670 on respective ones of the keyframe images 130 (Block 605). This may be performed programmatically using a blurring method 670 such as Gaussian blur, which blurs an image based on a Gaussian function. The blurring operation may incorporate the application of a filter to the underlying image. The blurring operation may, in some embodiments, adjust values for pixels in the underlying image based on values of neighboring pixels. In some embodiments, a small blur kernel may be used. For example, in some embodiments a radius of four pixels may be used. In some embodiments, a box-filter averaging process may be used. In some embodiments, an adaptive blurring process may be used that utilizes the mesh representation itself. For example, in some embodiments, a threshold for the blurring may be based on the quality of the 3D reconstruction and/or the pose estimation associated with the keyframe image. The blurred version of the image may be thought of as the “low” frequency version of the image (i.e., the low frequency image component 415), in that the blurring has removed the sharp or fine details of the image. As discussed above, the “low” frequency version of the image may include color and tones.

To generate the high frequency image components 410, a difference between the blurred “low” frequency image and the original keyframe image 130 may be determined (Block 615). This may be performed programmatically, for example, using a pixel-by-pixel subtraction method. The resultant difference may be thought of as the “high” frequency version of the image. As discussed above, the “high” frequency version of the image may include fine details (e.g., blemishes, birthmarks, lines, pores, and so on), but might not include color or tone data. The blurred image may be stored as the low frequency image component 415 of the image and the difference between the low frequency image components 415 and the keyframe images 130 may be stored as the high frequency image component 410 of the image. It is noted that summing the high frequency image component 410 and the low frequency image component 415 results in the original keyframe image 130.

As another example, FIG. 6C is a block diagram, and FIG. 6D is a flowchart, of operations to extract high frequency image components 410′ and low frequency image components 415′ from the keyframe images 130, according to embodiments of the inventive concepts. As illustrated in FIGS. 6C and 6D, intermediate image components may be generated from the keyframe images 130. For example, high frequency intermediate image components 684, middle frequency intermediate image components 682, and low frequency intermediate image components 680 may be extracted for each of the respective keyframe images 130.

Extracting the intermediate image components may include performing a series of blurring operations on the keyframe images. For example, for each of the keyframe images 130, a plurality (e.g., two) of blurring operations (e.g., blurring operation 670 of FIG. 6B) may be performed. In some embodiments, a first blurring operation may be performed on the keyframe image 130 to generate a first blurred image, and a second blurring operation may be performed on the first blurred image to generate a second blurred image. Blurring operations 670 (see FIG. 6B) such as those discussed herein with respect to FIGS. 6A and 6B may be used for the generation of the first and second blurred images (e.g., a Gaussian blur, a box-filter averaging, etc.). In some embodiments, a first blurring threshold for the first blurring operation may be different than a second blurring threshold for the second blurring operation. In some embodiments, a threshold for the first and second blurring operations may be based on the quality of the 3D reconstruction and/or the pose estimation associated with the keyframe image. The blurred images may be constructed, for example, in accordance with a Gaussian pyramid. Though examples have been provided for the first and second blurring operations, it will be understood that other blurring operations and/or algorithms may be used without deviating from the embodiments described herein.

In some embodiments, the blurred images may then be combined to generate a Difference of Gaussians (DoG) pyramid or a Laplacian pyramid. Intermediate image components may be extracted and/or based on the different levels of the resulting (e.g., DoG) pyramid. For example, extracting the low frequency intermediate image components 680 from the keyframe images 130 (Block 625) may include using the second blurred image (e.g., performing the second blurring operation on the first blurred image). Extracting the middle frequency intermediate image components 682 from the keyframe images 130 (Block 635) may include subtracting the second blurred image from the first blurred image. Extracting the high frequency intermediate image components 684 from the keyframe images 130 (Block 645) may include subtracting the first blurred image from the keyframe image 130. As noted, extracting intermediate image components may be constructed in accordance with images of a Differences of Gaussian (DOG) pyramid and/or a Laplacian pyramid. In this form of frequency decomposition, a summation of each of the three levels of the DoG or Laplacian pyramid would result in the original keyframe image 130. As discussed herein, subtracting a first image from a second image may include a pixel-by-pixel subtraction of the data channels (e.g., the RGB channels).

Though the embodiments described herein describe the use of two blurred images with three levels of a DoG or Laplacian image pyramid, it will be understood that other configurations may be possible without deviating from the inventive concepts. For example, additional levels of blurring may be provided and/or different levels of the DoG or Laplacian image pyramid may be used for the high frequency intermediate image components 684, the middle frequency intermediate image components 682, and/or the low frequency intermediate image components 680.

Once the low, middle, and low frequency intermediate image components 680, 682, 684 have been generated, the high frequency image components 410′ may be generated by merging the high frequency intermediate image components 684 with the middle frequency intermediate image components 682 (Block 655). Merging the high frequency intermediate image components 684 with the middle frequency intermediate image components 682 may include, for each of the image components, a pixel-wise combination of the image components. For example, for each corresponding pixel of respective ones of the high frequency intermediate image components 684 and the middle frequency intermediate image components 682, the data channels (e.g., the RGB channels) for the pixel may be individually summed.

The low frequency image components 415′ may be generated by merging the low frequency intermediate image components 680 with the middle frequency intermediate image components 682 (Block 665). Merging the low frequency intermediate image components 680 with the middle frequency intermediate image components 682 may include, for each of the image components, a pixel-wise combination of the image components in a manner similar to that used to formulate the high frequency image components 410′.

As illustrated in FIGS. 6C and 6D, the use of frequency decomposition to generate the intermediate image components 680, 682, 684 provides a surprising technical effect. The intermediate image components reduce the amount of ghosting in the final texture atlas. In some embodiments, a particular type of ghosting, which may be referred to as a halo effect, may also be reduced. The halo effect may occur in a texture atlas when there are strong edges in the underlying keyframe images (e.g., in areas of otherwise uniform color). The cause of the halo effect may be an imperfect pose, 3D reconstruction and/or non static objects. Generally, the better the pose/3D reconstruction, and the more static the object, the less the halo effect will appear. In some embodiments, when the underlying keyframe images include an imperfect pose/3D reconstruction, the low frequency texture atlas may lose more frequency information then was intended. A small band of missing frequencies may be lost when using the frequency separation approach. The use of the frequency decomposition technique illustrated in FIGS. 6C and 6D, which utilizes image components containing portions of overlapping frequencies, may help reduce and/or prevent this effect.

For example, in some situations, ghosting may be due, in part, to inaccuracies in the pose estimation used in generating the mesh representation. The amount of blurring this corresponds to can be hard to predict beforehand. However, if one assumes a 3D reconstruction algorithm that is reasonably stable, and dealing repeatedly with the same camera(s) that has been placed reasonably to gather views evenly around the 3D object, there may be (statistically speaking) little bias for positions or directions in the extra blurring. The blurring amount may be similar over many different scans, given constancy of the above described parameters. The embodiments described with respect to FIGS. 6C and 6D take advantage of these observations. Instead of accumulating a low frequency version that is the perfect complement of the high frequency (as in the embodiments of FIGS. 6A and 6B), the embodiments of FIGS. 6C and 6D provide overlap between the high and low frequencies. Thus, the high frequency image components 410′ and the low frequency image components 415′ will no longer have a strict decomposition. In other words, the original keyframe images 130 may not equal the sum of the high frequency image components and the low frequency image components. The embodiments of FIGS. 6C and 6D provide this frequency overlap by using separate blurring filters for generating the high frequency image components and the low frequency image components.

Though the embodiments of FIGS. 6C and 6D are described herein as sub-operations of the flowchart of FIG. 5, in which the texturing operation 429 incorporating seam leveling is used, it will be understood that the use of intermediate image components may be utilized with other texturing operations 429 to beneficial effect. In other words, the use of separate blurring filters to develop the intermediate image components prior to generating the high frequency image components 410′ and the low frequency image components 415′ may be used with other texture atlas generation operations that utilize frequency separation without deviating from the embodiments described herein.

The various embodiments described herein may be characterized as an open-ended hybrid approach. The techniques may use conventional texturing operations, such as the mvs-texturing library, but avoid the texture atlas deficiencies that may result therefrom. In the techniques described herein, the texturing operation 429 is not exposed to the original data (e.g., the original keyframe images 130) as is conventionally done. Instead, the embodiments described herein perform as a post-processing step a frequency separation approach of each keyframe image 130, yielding two images from each camera view: a low frequency image component 415, 415′ and a high frequency image component 410, 410′.

The texturing operation 429 may process the high frequency image component 410, 410′ as it would conventionally process images. However, an improvement described herein includes operations in which the texturing that is performed on the high frequency image components 410, 410′ may not require global seam leveling. The images that form the high frequency image components 410, 410′ may have a similar level to begin with, as the average value and the lower frequencies have been removed. The low frequency image components 415, 415′ are handled separately in a simpler fashion, utilizing weighted averaging and accumulated into the low frequency texture atlas 435.

A benefit of the embodiments described herein over most existing approaches is that they provide an efficient way to include information from all of the keyframe images. The post-processing operations involving the low frequency accumulation is very efficient, and may be linear in both CPU and memory utilization with the number of keyframe images. This is in contrast to some conventional approaches that are based solely on Markov random fields, which may increase in a combinatorial fashion. For example, processing 20 keyframe images through a texturing operation like the mvs-texturing algorithm may take on the order of seconds, while processing 200 keyframe images may take on the order of hours. The embodiments described herein also benefit in that all of the keyframe images may be provided to generate the low frequency texture atlas, while, in some embodiments, only a subset of the high frequency image components may be provided to generate the high frequency texture atlas. The use of all of the keyframe images for the low frequency texture atlas (i.e., the use of each of the low frequency image components) may provide a higher dynamic range in the low frequency texture atlas as compared to operations which use a single keyframe image to generate portions of the texture atlas. For example, as discussed herein, the use of techniques such as the weighted averaging which allow each of the keyframe images (through the low frequency image components) to contribute to each triangle of the low frequency texture atlas provides a higher dynamic range as compared to techniques which assign a single keyframe image per triangle. The higher dynamic range of the low frequency texture atlas may further provide a better and/or improved dynamic range of the resulting texture atlas. Thus, a high quality final texture atlas may be generated, while not requiring the full time to iterate over all of the keyframe images for the texturing operation.

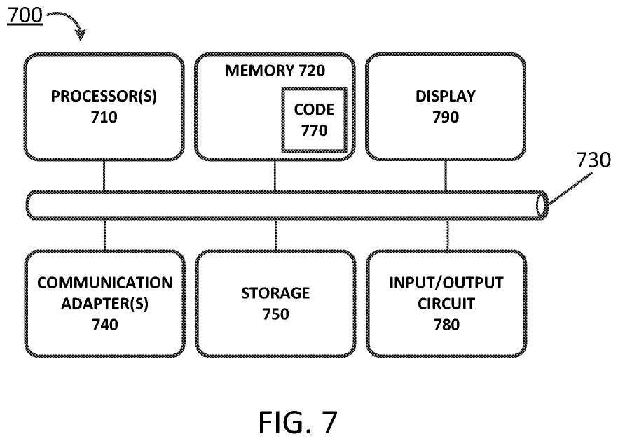

FIG. 7 is a block diagram of an electronic device 700 capable of implementing the inventive concepts, according to various embodiments described herein. The electronic device 700 may use hardware, software implemented with hardware, firmware, tangible computer-readable storage media having instructions stored thereon and/or a combination thereof, and may be implemented in one or more computer systems or other processing systems. The electronic device 700 may also utilize a virtual instance of a computer. As such, the devices and methods described herein may be embodied in any combination of hardware and software. In some embodiments, the electronic device 700 may be part of an imaging system containing the camera 100. In some embodiments, the electronic device 700 may be in communication with the camera 100 (or a device containing the camera 100) illustrated in FIG. 1.

As shown in FIG. 15, the electronic device 700 may include one or more processors 710 and memory 720 coupled to an interconnect 730. The interconnect 730 may be an abstraction that represents any one or more separate physical buses, point to point connections, or both connected by appropriate bridges, adapters, or controllers. The interconnect 730, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

The processor(s) 710 may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices, which may be collocated or distributed across one or more data networks. The processor(s) 710 may be configured to execute computer program instructions from the memory 720 to perform some or all of the operations for one or more of the embodiments disclosed herein.

The electronic device 700 may also include one or more communication adapters 740 that may communicate with other communication devices and/or one or more networks, including any conventional, public and/or private, real and/or virtual, wired and/or wireless network, including the Internet. The communication adapters 740 may include a communication interface and may be used to transfer information in the form of signals between the electronic device 700 and another computer system or a network (e.g., the Internet). The communication adapters 740 may include a modem, a network interface (such as an Ethernet card), a wireless interface, a radio interface, a communications port, a PCMCIA slot and card, or the like. These communication components may be conventional components, such as those used in many conventional computing devices, and their functionality, with respect to conventional operations, is generally known to those skilled in the art. In some embodiments, the communication adapters 740 may be used to transmit and/or receive data associated with the embodiments for creating the mesh representation and/or texture atlas described herein. For example, the processor(s) 710 may be coupled to the one or more communication adapters 740. The processor(s) 710 may be configured to communicate via the one or more communication adapters 740 with a device that provides image data (such as another electronic device 100) and/or with a 3D printer (e.g., to print a 3D representation based on the mesh representation and/or texture atlas described herein). In some embodiments, the electronic device 700 may be in communication with the camera 100 (or a device containing the camera 100) illustrated in FIG. 1 via the one or more communication adapters 740.

The electronic device 700 may further include memory 720 which may contain program code 770 configured to execute operations associated with the embodiments described herein. The memory 720 may include removable and/or fixed non-volatile memory devices (such as but not limited to a hard disk drive, flash memory, and/or like devices that may store computer program instructions and data on computer-readable media), volatile memory devices (such as but not limited to random access memory), as well as virtual storage (such as but not limited to a RAM disk). The memory 720 may also include systems and/or devices used for storage of the electronic device 700.

The electronic device 700 may also include one or more input device(s) such as, but not limited to, a mouse, keyboard, camera (e.g., camera 100 of FIG. 1), and/or a microphone connected to an input/output circuit 780. The input device(s) may be accessible to the one or more processors 710 via the system interconnect 730 and may be operated by the program code 770 resident in the memory 720

The electronic device 700 may also include a display 790 capable of generating a display image, graphical user interface, and/or visual alert. The display 790 may be accessible to the processor 710 via the system interconnect 730. The display 790 may provide graphical user interfaces for receiving input, displaying intermediate operations/data, and/or exporting output of the embodiments described herein.

The electronic device 700 may also include a storage repository 750. The storage repository 750 may be accessible to the processor(s) 710 via the system interconnect 730 and may additionally store information associated with the electronic device 700. For example, in some embodiments, the storage repository 750 may contain mesh representations, texture atlases, image data and/or point cloud data as described herein. Though illustrated as separate elements, it will be understood that the storage repository 750 and the memory 720 may be collocated. That is to say that the memory 720 may be formed from part of the storage repository 750.

In the above-description of various embodiments, it is to be understood that the terminology used herein is for the purpose of describing particular embodiments only and is not intended to be limiting of the embodiments as described herein. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

When an element is referred to as being “connected,” “coupled,” “responsive,” or variants thereof to another element, it can be directly connected, coupled, or responsive to the other element or intervening elements may be present. In contrast, when an element is referred to as being “directly connected,” “directly coupled,” “directly responsive,” or variants thereof to another element, there are no intervening elements present. Furthermore, “coupled,” “connected,” “responsive,” or variants thereof as used herein may include wirelessly coupled, connected, or responsive. As used herein, the singular forms “a,” “an,” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise,” “comprising,” “comprises,” “include,” “including,” “includes,” “have,” “has,” “having,” or variants thereof are open-ended, and include one or more stated features, integers, elements, steps, components or functions but does not preclude the presence or addition of one or more other features, integers, elements, steps, components, functions or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-Ray).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module,” or variants thereof.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination. Many variations and modifications can be made to the embodiments without substantially departing from the principles of the present invention. All such variations and modifications are intended to be included herein within the scope of the present invention.

1. A method of generating a texture atlas comprising:
extracting a plurality of high frequency image components and a plurality of low frequency image components from a plurality of two-dimensional (2D) images of a three-dimensional (3D) object captured at respective points of perspective of the 3D object;
generating a low frequency texture atlas from the plurality of low frequency image components;
generating a high frequency texture atlas from the plurality of high frequency image components by performing a texturing operation comprising seam leveling on a subset of the plurality of high frequency image components; and
generating the texture atlas by merging the low frequency texture atlas with the high frequency texture atlas.

2. The method of claim 1, wherein extracting the plurality of low frequency image components from the plurality of 2D images of the 3D object comprises performing a blurring operation on respective ones of the plurality of 2D images.

3. The method of claim 1, wherein extracting the plurality of high frequency image components from the plurality of 2D images comprises subtracting respective ones of the low frequency image components from respective ones of the plurality of 2D images.

4. The method of claim 1, further comprising:
extracting a plurality of high frequency intermediate image components from the plurality of 2D images;
extracting a plurality of middle frequency intermediate image components from the plurality of 2D images; and
extracting a plurality of low frequency intermediate image components from the plurality of 2D images,
wherein extracting the plurality of high frequency image components comprises merging the plurality of high frequency intermediate image components and the plurality of middle frequency intermediate image components, and
wherein generating the plurality of low frequency image components comprises merging the plurality of low frequency intermediate image components and the plurality of middle frequency intermediate image components.

5. The method of claim 4, further comprising:
generating a plurality of first blurred images by performing a blurring operation on respective ones of the plurality of 2D images, and
generating a plurality of second blurred images by performing the blurring operation on respective ones of the plurality of first blurred images.

6. The method of claim 5, wherein extracting the plurality of low frequency intermediate image components from the plurality of 2D images comprises selecting the plurality of second blurred images,
wherein extracting the plurality of middle frequency intermediate image components from the plurality of 2D images comprises subtracting respective ones of the plurality of second blurred images from respective ones of the plurality of first blurred images, and
wherein extracting the plurality of high frequency intermediate image components from the plurality of 2D images comprises subtracting respective ones of the plurality of first blurred images from respective ones of the plurality of 2D images.

7. The method of claim 1, wherein a first number of the subset of the plurality of high frequency image components is less than a second number of the plurality of low frequency image components.

8. The method of claim 1, further comprising selecting a first high frequency image component of the plurality of high frequency image components as part of the subset of the plurality of high frequency image components based on a quality of the first high frequency image component, an orientation of the first high frequency image component with respect to the 3D object, and/or a distance to the 3D object from which the first high frequency image component was captured.

9. The method of claim 1, wherein the texturing operation comprising seam leveling comprises a Markov random field optimization operation.

10. The method of any of claim 1, wherein generating the low frequency texture atlas based on the plurality of low frequency image components comprises summing, for each low frequency image component of the plurality of low frequency image components, a color value of the low frequency image component multiplied by a weight value.

11. A computer program product for operating an imaging system, the computer program product comprising a non-transitory computer readable storage medium having computer readable program code embodied in the medium that when executed by a processor causes the processor to perform the method of claim 1.

12. A system for processing images, the system comprising:
a processor; and
a memory coupled to the processor and storing computer readable program code that when executed by the processor causes the processor to perform operations comprising:
extracting a plurality of high frequency image components and a plurality of low frequency image components from a plurality of two-dimensional (2D) images of a three-dimensional (3D) object captured at respective points of perspective of the 3D object;
generating a low frequency texture atlas from the plurality of low frequency image components;
generating a high frequency texture atlas from the plurality of high frequency image components by performing a texturing operation comprising seam leveling on a subset of the plurality of high frequency image components; and
generating a texture atlas by merging the low frequency texture atlas with the high frequency texture atlas.

13. The system of claim 12, wherein extracting the plurality of low frequency image components from the plurality of 2D images of the 3D object comprises performing a blurring operation on respective ones of the plurality of 2D images.

14. The system of claim 12, wherein extracting the plurality of high frequency image components from the plurality of 2D images comprises subtracting respective ones of the low frequency image components from respective ones of the plurality of 2D images.

15. The system of claim 12, wherein the operations further comprise:
extracting a plurality of high frequency intermediate image components from the plurality of 2D images;
extracting a plurality of middle frequency intermediate image components from the plurality of 2D images; and
extracting a plurality of low frequency intermediate image components from the plurality of 2D images,
wherein extracting the plurality of high frequency image components comprises merging the plurality of high frequency intermediate image components and the plurality of middle frequency intermediate image components, and
wherein generating the plurality of low frequency image components comprises merging the plurality of low frequency intermediate image components and the plurality of middle frequency intermediate image components.

16. The system of claim 15, wherein the operations further comprise:
generating a plurality of first blurred images by performing a blurring operation on respective ones of the plurality of 2D images, and
generating a plurality of second blurred images by performing the blurring operation on respective ones of the plurality of first blurred images.

17. The system of claim 16, wherein extracting the plurality of low frequency intermediate image components from the plurality of 2D images comprises selecting the plurality of second blurred images,
wherein extracting the plurality of middle frequency intermediate image components from the plurality of 2D images comprises subtracting respective ones of the plurality of second blurred images from respective ones of the plurality of first blurred images, and
wherein extracting the plurality of high frequency intermediate image components from the plurality of 2D images comprises subtracting respective ones of the plurality of first blurred images from respective ones of the plurality of 2D images.

18. The system of claim 12, wherein a first number of the subset of the plurality of high frequency image components is less than a second number of the plurality of low frequency image components.

19. The system of claim 12, wherein the operations further comprise selecting a first high frequency image component of the plurality of high frequency image components as part of the subset of the plurality of high frequency image components based on a quality of the first high frequency image component, an orientation of the first high frequency image component with respect to the 3D object, and/or a distance to the 3D object from which the first high frequency image component was captured.

20. (canceled)

21. The system of claim 12, wherein generating the low frequency texture atlas based on the plurality of low frequency image components comprises summing, for each low frequency image component of the plurality of low frequency image components, a color value of the low frequency image component multiplied by a weight value.
